(19) United States
(12) Patent Application Publication
(10) Pub. No.: US 2005/0066210 A1
(43) Pub. Date: Mar. 24, 2005

(54) Digital network video and audio monitoring system

(76) Inventor: Hsien-Ping Chen, Taichung (TW)

Correspondence Address: DELLETT AND WALTERS, P. O. BOX 2786, PORTLAND, OR, 97208-2786, US

(21) Appl. No.: 10/668,720

(22) Filed: Sep. 22, 2003

(51) Int. Cl. G06F 1/26

(52) U.S. Cl. 713/340

(57) ABSTRACT

A digital network video and audio monitoring system includes a real time digital video and audio processing unit, a fast Ethernet switching unit and a self-protecting and alarming unit. The real time digital video and audio processing unit has multiple audio and video processing modules each made of an interface card and connected to a video and audio monitor. The fast Ethernet switching unit is connected to the real time digital video and audio processing unit and further connected to TCP/IP network. Therefore, monitoring signals from the video and audio monitor can be sent to the network. Further, the self-protecting and alarming unit is connected between an external AC power source and outputs of the video and audio monitors to detect whether any abnormal signals occur. The present invention can directly connect to one or more video and audio monitors and send the monitoring signals over the network.

### BACKGROUND OF THE INVENTION

1. Field of the Invention

The present invention relates to a digital network video and audio monitoring system, more specifically to a monitoring system that has easy operation and secure transmission capabilities.

2. Description of Related Art

A digital monitoring device is further connected to the network device and linked to a local area network (LAN), wide area network (WAN) etc. The digital data from the digital monitoring device can be transmitted over Internet and can be easily and conveniently stored in storage devices. The distant Internet terminal can link to the Internet and further access the monitoring data. Therefore, the digital monitoring device has more functional and a better performance than the analog monitoring device.

There are at least three types of digital monitoring device, such as an IP camera system, video server system and DVR system. Each of the three types has a network interface to link to the LAN. The network interface can link to the TCP/IC network and send the monitoring data over Internet. However, the three types are individual monitoring devices and monitor conditions for one limited area.

To monitor more conditions in a large area, more digital monitoring devices, other digital connectors, such as a Hub or Switch and a main controller are used. If the monitoring data from the digital monitoring devices needs to be sent over Internet, the digital monitoring devices are further connected to the network devices such as Router or ADSL modem. That is, using the digital monitoring device to monitor conditions in the large places, for example a company, an office or a parking area requires lots of external network devices and understanding of the operations of digital connector and network devices.

As mentioned above, the individual digital monitoring device is not adapted to be installed in the large place unless when using other digital monitoring devices and other more network devices. Besides, although the digital monitoring device can connect to the Internet through the TCP/IP network, it does not have an Internet security function so the monitored data over network could be stolen. Therefore, the digital monitoring device is not adapted to set up in a company or office premises.

To overcome the shortcomings, the present invention provides a digital network video and audio monitoring system to mitigate or obviate the aforementioned problems.

### SUMMARY OF THE INVENTION

An objective of the present invention is to provide a digital network video and audio monitoring system that is directly connected to TCP/IP network and multiple analog video and audio devices. The present invention does not need external digital connectors to connect many monitoring devices nor external network devices to connect to TCP/IP network. Therefore, the present invention has an easy installation capability.

Other objectives, advantages and novel features of the invention will become more apparent from the following detailed description when taken in conjunction with the accompanying drawings.

### BRIEF DESCRIPTION OF THE DRAWINGS

FIG. 1 is an operational view of the digital network video and audio system and other network terminals over network;

FIG. 2 is a block diagram of a digital network video and audio monitoring system in accordance with the present invention;

FIG. 3 is an exploded perspective view of the digital network video and audio system in accordance with the present invention;

FIG. 4 is a block diagram of a partial of FIG. 1;

FIG. 5 is a perspective view of a first embodiment of the digital network video and audio system in accordance with the present invention;

FIG. 6 is a perspective view of a second embodiment of the digital network video and audio system in accordance with the present invention; and

FIG. 7 is a block diagram of a partial of FIG. 1.

### DETAILED DESCRIPTION OF THE PREFERRED EMBODIMENT

A digital network video and audio monition system in accordance with the present invention is directly connected to digital I/O devices or analog video and audio devices and connects to TCP/IP network.

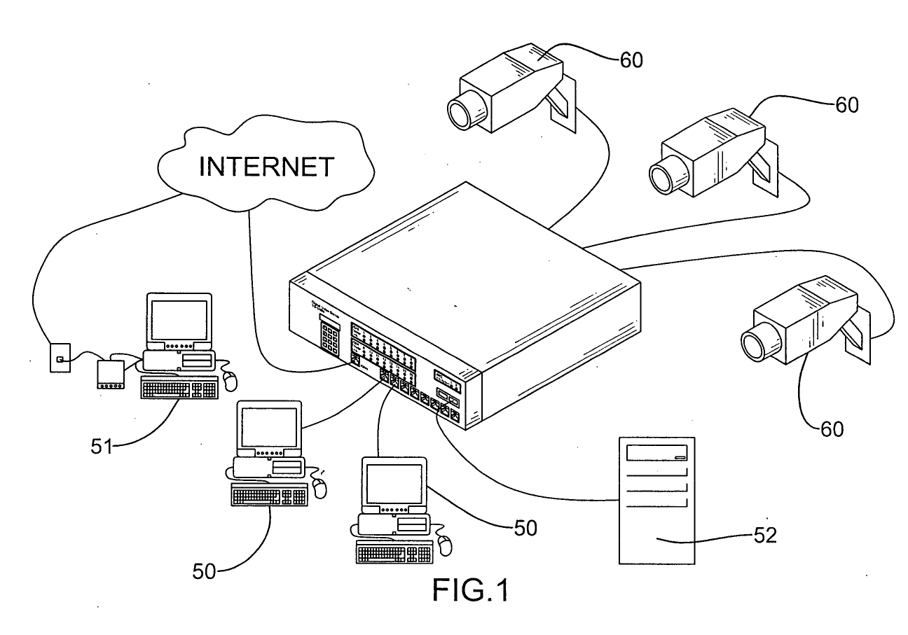

With reference to FIG. 1, the monitoring system is connected to LAN terminals (50), a WAN terminal (51), a storage device (52) and multiple video and audio devices (60). The storage device (52) could be a disk array device, a network attached storage device (NAS) or a storage area network device (SAN).

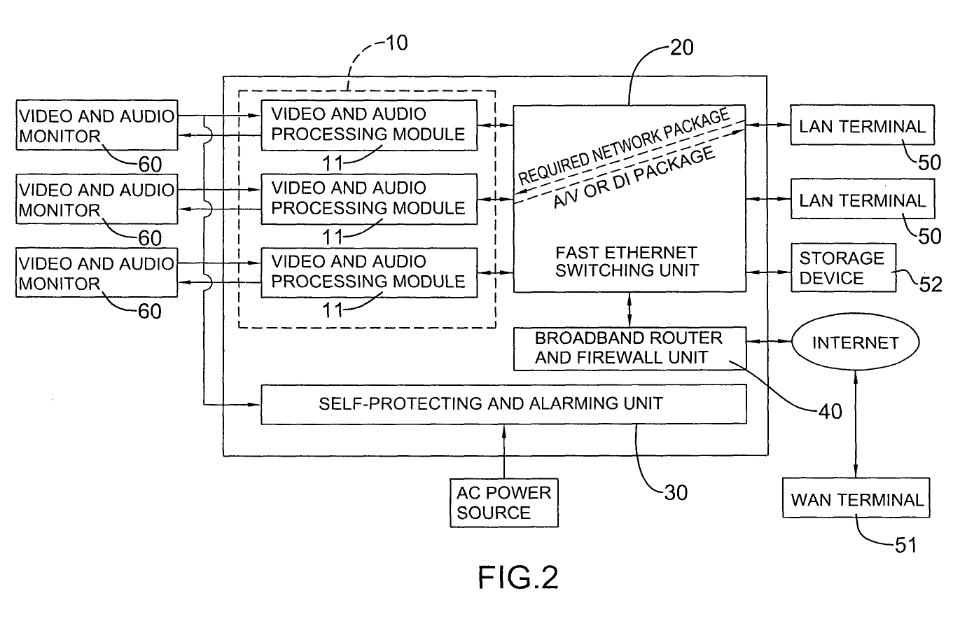

With reference to FIG. 2, the monitoring system in accordance with the present invention includes a real time digital video and audio processing unit (10), a fast Ethernet switching unit (20) and a self-protecting and alarming unit (30).

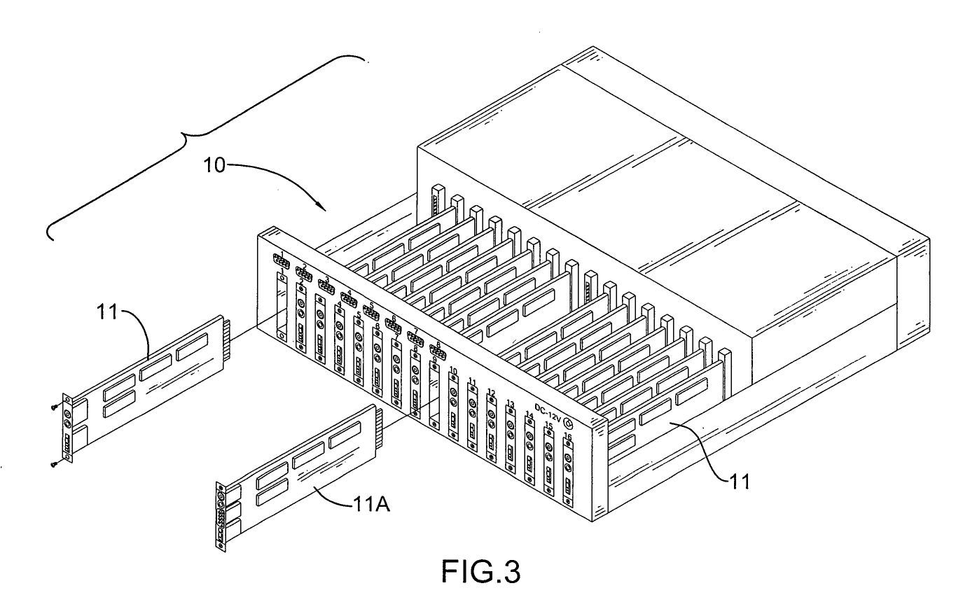

The real time digital video and audio processing unit (10) has multiple audio and video processing modules (11). Each audio and video processing module (11) is connected to a video and audio monitor (60) to obtain the video and audio signal. Each audio and video module (11, 11A) can be formed as an interface card as shown in FIG. 3.

The fast Ethernet switching unit (20) is connected to the real time digital video and audio processing unit (10). The fast Ethernet switching unit (20) has a media access controller (MAC) address table connected to WAN Interface. Therefore, the fast Ethernet switching unit (20) connects to TCP/IP network through the WAN interface and transmits or receives network packages with an IP address to the LAN and/or WAN terminals (50, 51).

The self-protecting and alarming unit (30) is connected between an external AC power source (not shown) and outputs of the video and audio monitors (60) and determines whether any abnormal signals from the AC power source or the video and audio monitor (60) occur. If the AC power source or video and audio monitor (60) outputs abnormal signals, the self-protecting and alarming unit (30) will output a high decibel alarming sound.

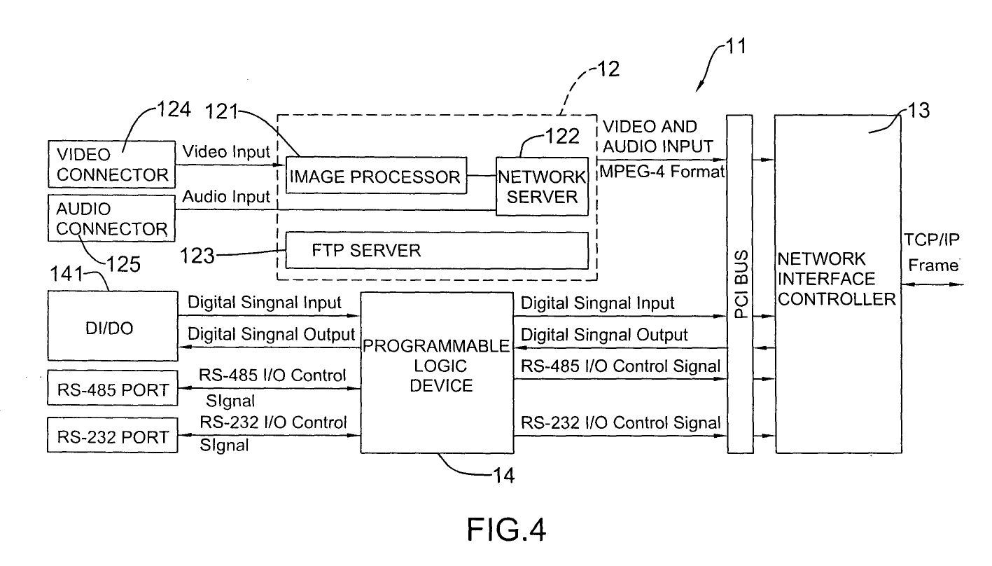

With reference to FIGS. 2 and 4, each audio and video processing module (11) has a programmable media processor (12), a network interface controller (13), and a programmable logic device (14).

The programmable media processor (12) is connected to an output of the video and audio monitor (60) through a video connector (124) and an audio connector (125) and has an image processor (121), a network server (122) and a file transfer protocol (FTP) server (123). The network server (122) establishes a TCP/IP operation platform and sets up a platform's states as the module's name, system time, IP address of the system, user name, HTTP platform, operations of the video and audio monitor, alarming function, protocol parameters etc. The programmable media processor (12) transfers the video and audio signals from the video and audio monitor (60) to a specific digital signal.

The network interface controller (13) is connected between an output of the programmable media processor (12) through a PCI bus and inputs of the fast Ethernet switching unit (20). The network interface controller (13) is set up an IP address and transfers the specific digital signal to network packages with the IP address and outputs the network packages to the fast Ethernet switching unit (20). The IP address of the network interface controller (13) can be a virtual or a published IP address.

The programmable logic device (14) is connected to external devices and the network interface controller (13) through the PCI bus and receives a command signal from the LAN or WAN terminals (50, 51). The command signal is used to control the external devices connected to the programmable logic device (14). The external device could be a controller of the video and audio monitor (60) or a modem (not shown). The programmable logic device (14) is connected to the video and audio monitor through a digital input/digital output (DI/DO) port and an RS-485 port and is connected to the modem through an RS-232 port. With further reference to FIG. 3, The video and audio processing module (11) is an interface card so the present invention can provide two types of interface cards (11, 11A) with different connectors. One type has a video connector (BNC connector), an audio connector (RAC connector), a DI/DO port, an RS-485 port and the other type has a video connector (BNC connector), an audio connector (RAC connector), a DI/DO port, an RS-485 port and an RS-232 port.

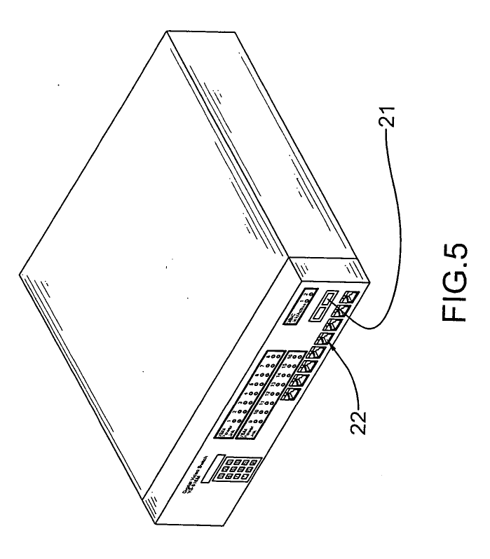

With reference to FIG. 5, the fast Ethernet switching unit (shown in FIG. 2) connects to the TPC/IP network and further has two different interfaces based on different LAN bandwidths, wherein one is gigabit interface (21) and the other is a megabit interface (22).

With reference to FIGS. 2 and 4, the LAN terminal (50) and the video and audio processing module (11) are connects to the same LAN, so a LAN terminal (50) can appoint and send required network packages to the present invention to obtain the specific video and audio monitor's monitoring signal or more video and audio monitors' signals. When the fast Ethernet switching unit (20) receives the required network package, the fast Ethernet switching unit (20) can transmit the required network package to the video and audio processing module (11) connected to the specific video and audio monitor (60) by the virtual IP address from the required network package.

When the video and audio processing module (11) receives the required network package, the programmable media processor (12) transfers the video and audio signals to the specific signals and then the network interface controller (13) transfers the specific signals to IP network packages and sends the IP network packages to the fast Ethernet switching unit (20). The fast Ethernet switching unit (20) outputs the IP network packages to the LAN terminal (50). Therefore, the LAN terminal (50) can obtain the monitoring signals from the present invention.

With reference to FIG. 2, the monitoring system further includes a broadband router and firewall unit (40) connected to the fast Ethernet switching unit (20). The broadband router and firewall unit (40) is directly connected to the WAN and can be set up a published IP address, a policy table and a routing table (not shown). The policy table can be set up multiple published IP addresses of the WAN terminals.

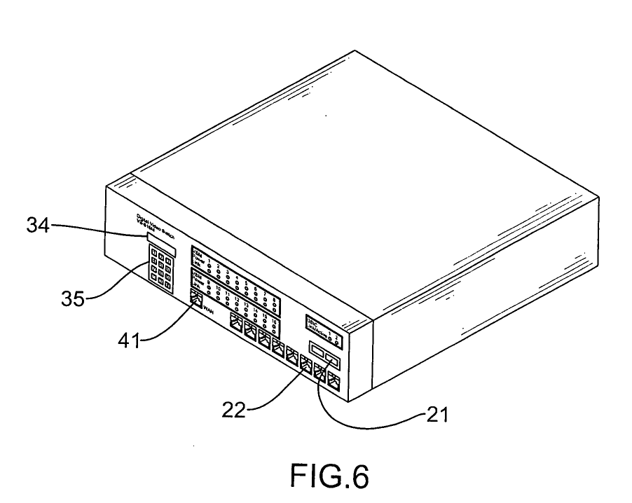

When a WAN terminal (51) sends a required network package to the present invention, the broadband router and firewall unit (40) checks the published IP address in the policy table to identify whether the WAN terminal (51) has right to access the video and audio signals from the present invention. If not, the broadband router and firewall unit (40) will interrupt the connection between the present invention and the WAN terminal (51). Therefore, the present invention with the broadband router and firewall unit (40) can prevent the monitoring packages sent over the WAN being stolen. With reference to FIG. 6, the broadband router and firewall unit (40) has a WAN port (41) to connect to the WAN wire.

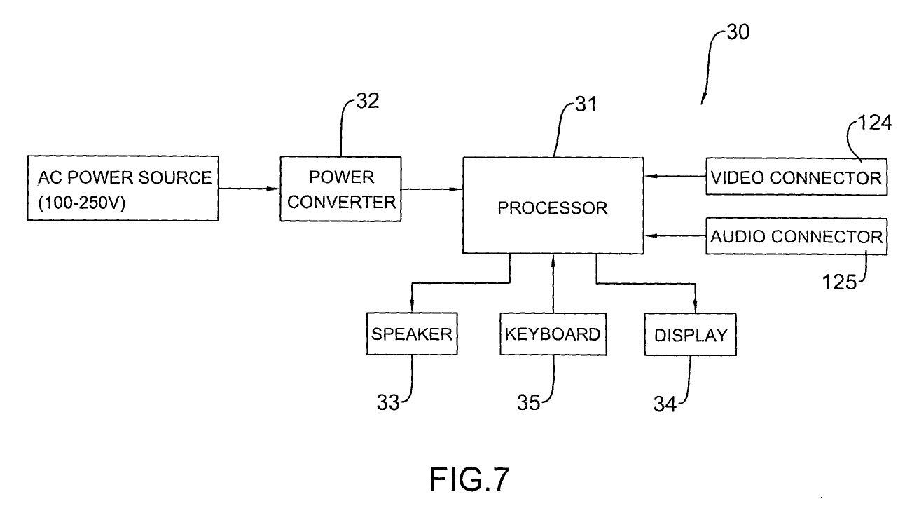

With reference to FIG. 7, the self-protecting and alarming unit (30) is composed of a processor (31), a power converter (32), a speaker (33), a display (34) and a keyboard (35).

The processor (31) has a program to determine abnormal signals of a power source and the video and audio monitors (shown in FIG. 2). The processor (31) is connected to the video and audio monitors through the video and audio connectors (124, 125).

The power converter (32) is connected between the processor (31) and the AC power source. The power converter (32) converts the AC power to DC power and then outputs the DC power to the processor (32).

The speaker (33) and the display (34) are connected to outputs of the processor (31) and the keyboard (35) is connected to the input of the processor (31).

The processor (31) obtains the DC power through the power converter (32) and the monitoring signal through the video and audio connectors (124, 125) so the processor (31) can determine whether the power source and monitoring signal are normal or not. If the signal is abnormal, the processor (31) controls the speaker (33) to output an alarming sound and output the alarming words on the display (34) to notify a system manager. The system manager can use the keyboard (35) to cancel the alarming sound.

Based on the forgoing description, the present invention has several advantages as follow:

1. The present invention has a digital monitoring and a network package switching capabilities so the present invention can provide the distant LAN or WAN terminal to monitoring conditions in the local place where the present invention is installed.

2. The present invention directly links to the TCP/IP network without external network devices and has an Internet security function. Each video and audio processing module can be set up the virtual IP address or published IP address so the video and audio monitors are connected to the video and audio processing modules are a network device. Therefore, any LAN terminal can be connected to the video and audio devices over the network and obtain monitoring signals of those devices.

3. The present invention has a self-protection and alarm capability.

4. The present invention does not have a complex operation system (OS) and only has a protocol platform so the present invention has good stability and reliability.

5. The present invention is without a specific OS so the present invention can connect to different types of storage devices.

6. The present invention has short maintenance time. The video and audio process module is comprised of the interface card so any faulty interface card can be easily replaced with a new one. Therefore, the maintenance time can be efficiently reduced in comparison with the prior art.

7. The present invention has a hot-swapping capability. The video and audio processing module is formed as the interface card so the video and audio processing module can be directly replaced with a new one while the present invention is operating.

8. The present invention provides two different types of the video and audio process modules to a system manager. The system manager can use one of the two types corresponding to the type of the external devices.

Briefly, the present invention can connect to one or a plurality of video and audio monitors so the present invention is adapted to be installed anywhere to monitor conditions in the installation area. Further, the present invention can link to a LAN or a WAN, so the present invention is easily adapted to install in a company with Intranet and also provides the distant terminal over the Internet (WAN) to link the local place to obtain the local monitoring signals.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A digital network video and audio monitoring system, comprising:
a real time digital video and audio processing unit having multiple audio and video processing modules, wherein the audio and video processing modules are respectively connected to video and audio monitors to obtain monitoring signals from the video and audio monitors;
a fast Ethernet switching unit connected to outputs of the real time digital video and audio processing unit, wherein the fast Ethernet switching unit has a media access controller (MAC) address table connected to WAN Interface; and
a self-protecting and alarming unit connected between an external AC power source and outputs of the video and audio monitors to detect abnormal signals from the external AC power source or the video and audio monitors, wherein when the external AC power source or any video and audio monitor outputs an abnormal signal, the self-protecting and alarming unit will output an alarming signal.

2. The monitoring system as claimed in claim 1, each video and audio processing module comprising:
a programmable media processor connected to the video and audio monitor, and having an image processor, a network server and a file transfer protocol (FTP) server, wherein the programmable media processor transfers the video and audio signals from the video and audio monitor to a specific digital signal;
a network interface controller connected between the programmable media processor through a PCI bus and the fast Ethernet switching unit, wherein the network interface controller is set up an IP address and transfers the specific digital signal to network packages with the IP address and outputs the network packages to the inputs of the fast Ethernet switching unit; and
a programmable logic device connected to external devices and the network interface controller through the PCI bus and receives a command signal that is to control operations of the external devices.

3. The monitoring system as claimed in claim 2, wherein
the network server establishes a TCP/IP operation platform and sets up a platform's states as a module's name, a system time, a system's IP address, a user name, an HTTP platform, operations of the video and audio monitor, an alarming function, protocol parameters; and
the external devices including a controller of each of the video and audio monitors and a modem.

4. The monitoring system as claimed in claim 3, wherein the programmable media processor further comprises a video connector and an audio connector that are respectively connected to the output of the video and audio monitor; and
the programmable logic device further comprises a DI/DO and an RS-485 port that are connected to a controller of the video and audio monitor.

5. The monitoring system as claimed in claim 4, wherein the programmable logic device further comprises an RS-232 port connected to the modem.

6. The monitoring system as claimed in claim 5, wherein the video connector is a BNC type and the audio connector is an RAC type.

7. The monitoring system as claimed in claim 1, wherein the fast Ethernet switching unit further comprises a gigabit interface and a megabit interface.

8. The monitoring system as claimed in claim 1, further comprising a broadband router and firewall unit connected to the fast Ethernet switching unit, wherein the broadband router and firewall unit was set up a published IP address.

9. The monitoring system as claimed in claim 8, wherein the broadband router and firewall unit has a policy table in which multiple published IP addresses of terminals over Internet are stored.

10. The monitoring system as claimed in claim 2, wherein the IP address of each network interface controller is a virtual or a published IP address.

11. The monitoring system as claimed in claim 4, wherein the self-protecting and alarming unit comprising:
a processor has a program to detect abnormal signals of the external AC power source and the video and audio monitors, wherein the processor is connected to the video and audio monitors through the video and audio connectors;
a power converter connected between input of the processor and the external AC power source, wherein the power converter converts the external AC power source to a DC power source and then outputs the DC power source to the processor;
a speaker connected to an output of the processor;
a display connected to the output of the processor; and
a keyboard connected to the input of the processor.
